(19) United States
(12) Patent Application Publication
(10) Pub. No.: US 2025/0315938 A1
(43) Pub. Date: Oct. 9, 2025

(54) RAIL INSPECTION DEVICE AND METHOD

(71) Applicants: SEMES CO., LTD., Cheonan-si (KR); Samsung Electronics Co., Ltd., Suwon-si (KR)

(72) Inventors: Sang Won KIM, Suwon-si (KR); Jong Hwan KIM, Suwon-si (KR); Hyung Hwan CHU, Suwon-si (KR)

(73) Assignees: SEMES CO., LTD., Cheonan-si (KR); Samsung Electronics Co., Ltd., Suwon-si (KR)

(21) Appl. No.: 18/801,854

(22) Filed: Aug. 13, 2024

(30) Foreign Application Priority Data
Apr. 3, 2024 (KR) 10-2024-0045038

(51) Int. Cl. G06T 7/00

(52) U.S. Cl. CPC G06T 7/001; G06T 2207/20021; G06T 2207/20081; G06T 2207/30184

(57) ABSTRACT

A rail inspection device is provided. The rail inspection device includes a traveling machine that travels along a rail and includes an optical system that acquires an image of an area of the rail being traveled; and a main body having the traveling machine installed on an upper surface and including an image analyzer that analyzes the image acquired from the optical system, wherein the image analyzer: sets at least one virtual area in the rail area image, extracts an item image of an inspection target item within the virtual area, and inspects the inspection target item by comparing the extracted item image with a normal image of the inspection target item.

### CROSS-REFERENCE TO RELATED APPLICATION

This application claims priority from Korean Patent Application No. 10-2024-0045038 filed on Apr. 3, 2024, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a rail inspection device and method.

### 2. Description of the Related Art

Overhead Hoist Transport (OHT) is installed in large hospitals, semiconductor or flat panel display production plants, etc. where there are many small objects to be transported. The OHT includes a transport vehicle that travels along a rail installed on a ceiling and transports an object, and a track with rails to guide the traveling of the transport vehicle.

When the OHT is installed on a semiconductor or display flat panel production line, a traveling rail is installed using a ceiling space in a clean room. The traveling rail is supported from the ceiling of the clean room by props, etc., and may include a traveling rail main body and a feed rail.

The transport vehicle traveling on the traveling rail transports transport objects loaded with semiconductor wafers, substrates, masks, glasses, or cassettes between transport ports. The transport vehicle may be equipped with a traveling driver and may travel within the traveling rail main body, and is operated by receiving power from the feed rail through a power receiving unit.

Meanwhile, after the installation of the OHT rail was completed, the operator confirms whether the rail was normally installed by directly measuring an installation state of the rail using a measuring device, etc. with a naked eye or a feeler inspection method. Inspection items for the installation status of the OHT rail include checking for scratches, damage, abnormal objects such as rail accessories or hand tools on the rail, or inspecting an assembly of rail components.

However, in the case of the above-described inspection method, reliability of the inspection may not be guaranteed as inspection results become uneven due to differences in inspection results depending on the competency and skill level of the operator even at the same location.

In addition, in the above-described inspection method, the inspection time is quite long, excessive costs are incurred, which causes a decrease in productivity, and there is an inherent risk of safety accidents due to work at heights.

### SUMMARY

Aspects of the present disclosure provide a rail inspection device with improved efficiency and safety in inspecting an installation status of an OHT rail.

Aspects of the present disclosure also provide a rail inspection method with improved efficiency and safety in inspecting an installation status of an OHT rail.

The objects of the present disclosure are not limited to those mentioned above and additional objects of the present disclosure, which are not mentioned herein, will be clearly understood by those skilled in the art from the following description of the present disclosure.

According to some embodiments of the present disclosure, there is provided a rail inspection device, comprising a traveling machine that travels along a rail and includes an optical system that acquires an image of an area of the rail being traveled; and a main body having the traveling machine installed on an upper surface and including an image analyzer that analyzes the image acquired from the optical system, wherein the image analyzer: sets at least one virtual area in the rail area image, extracts an item image of an inspection target item within the virtual area, and inspects the inspection target item by comparing the extracted item image with a normal image of the inspection target item.

According to some embodiments of the present disclosure, there is provided a rail inspection device, comprising a traveling machine that travels along a rail and includes an optical system that acquires an image of an area of the rail being traveled; and a main body having the traveling machine installed on an upper surface and including an image analyzer that analyzes the image acquired from the optical system, wherein the image analyzer: sets at least one virtual area in the rail area image, extracts an item image of an inspection target item within the virtual area, and inspects the inspection target item by comparing the extracted item image with a normal image of the inspection target item, the rail area image includes a plurality of rails that appear to have narrow intervals in a first direction toward a vanishing point, a plurality of Litz wire supports installed at intervals in the first direction between the plurality of rails, a plurality of yokes installed on the plurality of rails at intervals in a second direction toward the vanishing point, a plurality of turn buckles installed on the plurality of rails at equal intervals along the second direction with the yoke interposed therebetween and appearing to be disposed on both sides of the plurality of yokes in the first direction, and a ceiling support connected to upper portions of the plurality of turn buckles, the setting of the at least one virtual area in the rail area image divides the rail area image into the virtual area and the remaining area, and blurs the remaining area, when the virtual area includes a rectangular box shape elongated in the first direction in a lower area along a third direction perpendicular to the first direction and the second direction of the rail area image, and reveals information on the plurality of rails and the plurality of Litz wire supports, the image analyzer includes a plurality of algorithms through which the normal image of the inspection target item is trained, the inspection target item includes the plurality of rails and the plurality of Litz wire supports, and the item images of the plurality of rails and the plurality of Litz wire supports are acquired in real time through the optical system and used to inspect the presence/absence of abnormal objects including scratches, damage, particles, rail accessories, or hand tools on the plurality of rails and the plurality of Litz wire supports, when the virtual area includes a rectangular box shape formed at a central area according to the first direction of the rail area image and a third direction perpendicular to the first direction and the second direction, and reveals information on the yoke, the image analyzer includes a plurality of algorithms through which the normal image of the inspection target item is trained, the inspection target item includes the yoke, and the item image of the yoke is extracted only when the rail area image is acquired in real time through the optical system and the yoke is captured in the virtual area, and is used to inspect whether the yoke is normally installed, and when the virtual area includes a square box shape formed along a third direction perpendicular to the first direction and the second direction on both sides of the rail area image along the first direction, and partitions and reveals information on the plurality of turn buckles and the plurality of ceiling supports, the image analyzer includes a plurality of algorithms through which the normal image of the inspection target item is trained, the inspection target item includes the plurality of turn buckles and the plurality of ceiling supports, and the item images of the plurality of turn buckles and the plurality of ceiling supports are extracted only when the rail area image is acquired in real time through the optical system and the plurality of turn buckles and the plurality of ceiling supports are captured in the virtual area, and are used to inspect whether the plurality of turn buckles and the plurality of ceiling supports are normally installed.

According to some embodiments of the present disclosure, there is provided a rail inspection method comprising, providing a rail inspection device including: a traveling machine that travels along a rail and includes an optical system that acquires an image of an area of the rail being traveled; and a main body having the traveling machine installed on an upper surface and including an image analyzer that analyzes the image acquired from the optical system, setting at least one virtual area in the rail area image, extracting an item image of an inspection target item within the virtual area, and inspecting the inspection target item by comparing the extracted item image with a normal image of the inspection target item, wherein whether a rail is in a normal installation state is inspected by inspecting the presence/absence of an abnormal object to inspect an external state of the inspection target item or by inspecting an assembled state of the inspection target item.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic cross-sectional view for describing a traveling state of a rail inspection device according to some exemplary embodiments of the present disclosure;

FIG. 2 is a cross-sectional view schematically illustrating an OHT rail on which the rail inspection device according to some exemplary embodiments of the present disclosure travels;

FIGS. 3 and 4 are perspective views schematically illustrating the rail inspection device according to some exemplary embodiments of the present disclosure;

FIG. 5 is a schematic cross-sectional view for describing a state in which the rail inspection device according to some exemplary embodiments of the present disclosure travels on the OHT rail;

FIG. 6 is a diagram schematically illustrating a rail area image acquired by an optical system of the rail inspection device according to some exemplary embodiments of the present disclosure;

FIG. 7 is a cross-sectional view schematically illustrating a remote control of the rail inspection device according to some exemplary embodiments of the present disclosure;

FIG. 8 is a schematic diagram for describing inspecting an external state of the rail by setting a virtual area in the rail area image acquired by the optical system of the rail inspection device according to some exemplary embodiments of the present disclosure, extracting an item image of the rail within the virtual area, and then comparing the item image of the rail with a normal image of the rail;

FIG. 9 is a schematic diagram for describing inspecting an external state of the Litz wire support by setting a virtual area in the rail area image acquired by the optical system of the rail inspection device according to some exemplary embodiments of the present disclosure, extracting an item image of the Litz wire support within the virtual area, and then comparing the item image of the Litz wire support with a normal image of the Litz wire support;

FIG. 10 is a schematic diagram for describing inspecting whether the yoke is normally installed by setting a virtual area in the rail area image acquired by the optical system of the rail inspection device according to some exemplary embodiments of the present disclosure, extracting an item image of the yoke within the virtual area, and then comparing the item image of the yoke with a normal image of the yoke;

FIG. 11 is a schematic diagram for describing inspecting an assembled state of the turn buckles by setting a virtual area in the rail area image acquired by the optical system of the rail inspection device according to some exemplary embodiments of the present disclosure, extracting an item image of the turn buckle within the virtual area, and then comparing the item image of the turn buckle with a normal image of the turn buckle;

FIG. 12 is a schematic diagram for describing inspecting an assembled state of the ceiling supports by setting a virtual area in the rail area image acquired by the optical system of the rail inspection device according to some exemplary embodiments of the present disclosure, extracting an item image of the ceiling support within the virtual area, and then comparing the item image of the ceiling support with a normal image of the ceiling support; and

FIGS. 13 and 14 are flowcharts schematically illustrating a rail inspection method using the rail inspection device according to some exemplary embodiments of the present disclosure.

### DETAILED DESCRIPTION OF THE EMBODIMENTS

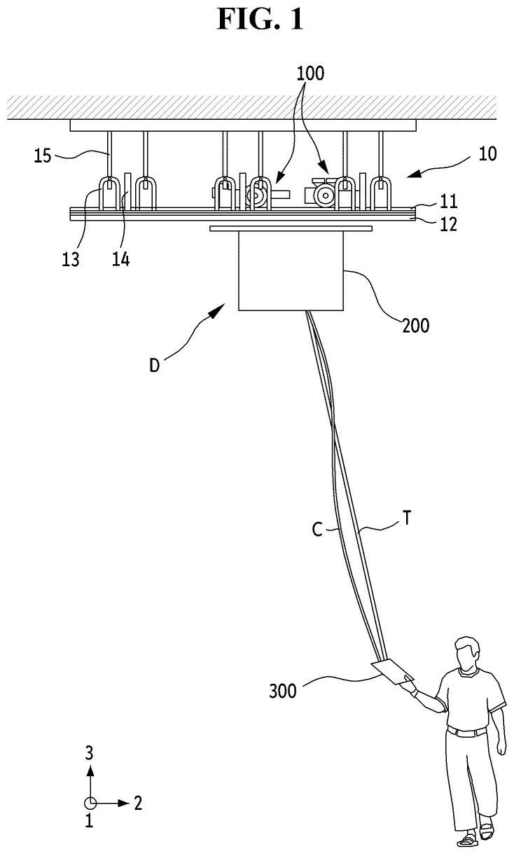

Hereinafter, a rail inspection device according to some embodiments of the present disclosure will be described with reference to FIGS. 1 to 5.

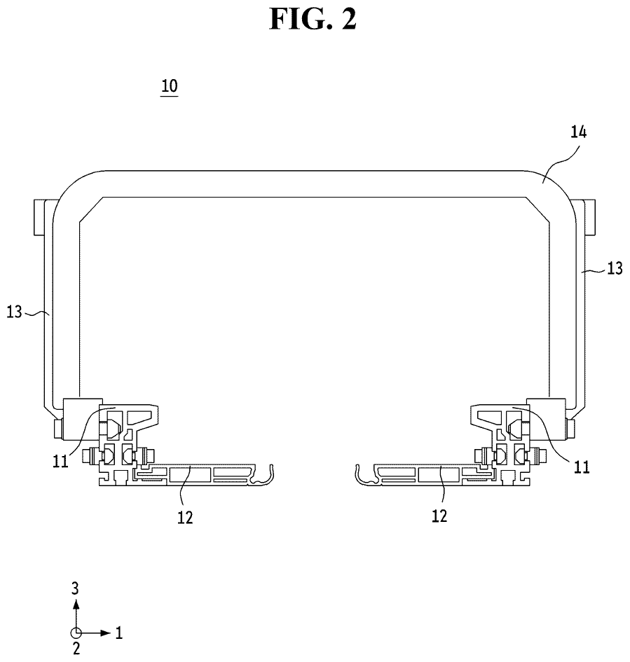

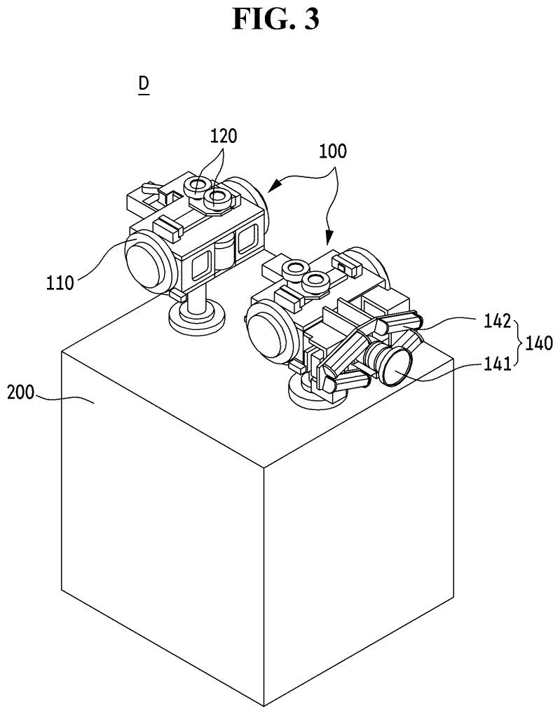

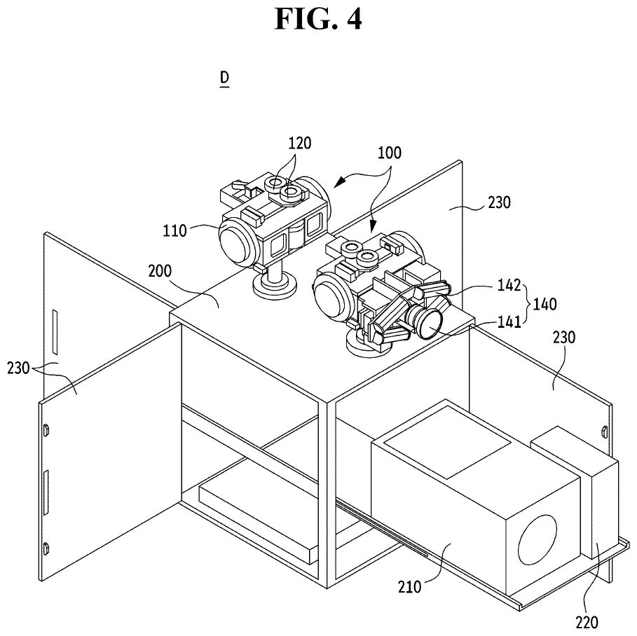

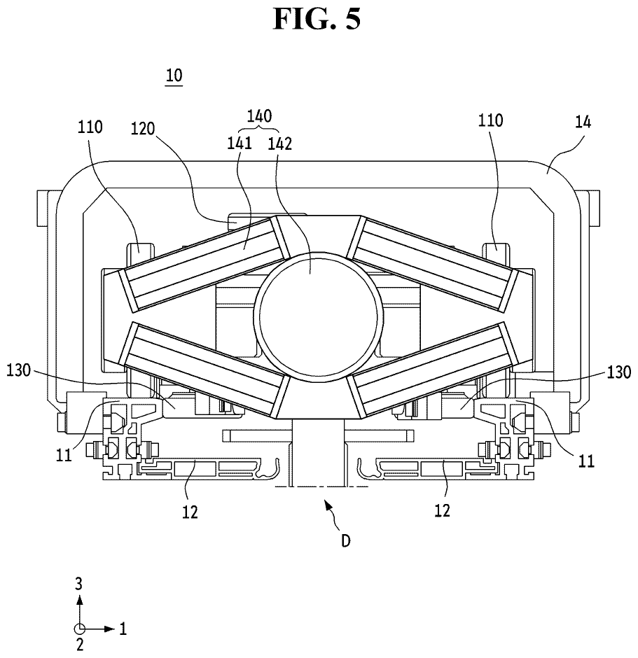

FIG. 1 is a schematic cross-sectional view for describing a traveling state of a rail inspection device according to some exemplary embodiments of the present disclosure. FIG. 2 is a cross-sectional view schematically illustrating an OHT rail on which the rail inspection device according to some exemplary embodiments of the present disclosure travels. FIGS. 3 and 4 are perspective views schematically illustrating the rail inspection device according to some exemplary embodiments of the present disclosure. FIG. 5 is a schematic cross-sectional view for describing a state in which the rail inspection device according to some exemplary embodiments of the present disclosure travels on the OHT rail.

Referring to FIGS. 1 to 5, a rail inspection device according to some exemplary embodiments of the present disclosure may include a traveling machine 100 and a main body 200.

Here, a first direction 1 and a second direction 2, which are horizontal directions, may form a plane. The first direction 1 may be a left-right direction, and the second direction 2 may be a front-back direction. Alternatively, the first direction 1 may be a front-back direction, and the second direction 2 may be a left-right direction. The third direction 3 is a height direction and is a direction perpendicular to the plane formed by the first direction 1 and the second direction 2. The third direction 3 may be an upward and downward direction.

The rail inspection device D according to some exemplary embodiments of the present disclosure may include a traveling machine 100. One or more traveling machines 100 may be disposed on the rail inspection device D.

FIGS. 1, 3, and 4 illustrate that the rail inspection device D includes two traveling machines 100, but the exemplary embodiment is not limited thereto. When two or more traveling machines 100 are disposed, the two or more traveling machines 100 may be disposed to be spaced apart from each other along the second direction 2, which is a traveling direction of the rail inspection device D. The two or more traveling machines 100 may be connected to each other through a connecting means such as a ring.

The traveling machine 100 may be disposed above the main body 200. The traveling machine 100 may be connected to an upper surface of the main body 200.

Referring to FIGS. 3 to 5, the traveling machine 100 may include a traveling wheel 110, a steering wheel 120, a guide wheel 130, and an optical system 140.

The traveling wheel 110 may rotate so that the traveling machine 100 may travel. The traveling wheels 110 may be configured as a pair disposed on both sides of the traveling machine 100 in the first direction 1. The traveling wheel 110 may be disposed on one side surface of the traveling machine 100 along the first direction 1 and on the other side surface opposite to the one side surface, respectively.

A pair of traveling wheels 110 may each rotate on a pair of rails 11 disposed on an OHT rail 10. By rotating the pair of traveling wheels 110, the traveling machine 100 may be moved while traveling. By moving the traveling machine 100, the rail inspection device D may move within the OHT rail 10.

When the pair of traveling wheels 110 each travel on the pair of rails 11, the pair of rails 11 may be disposed between the traveling machine 100 and the third direction 3 of the main body 200. The pair of rails 11 is disposed at intervals in the first direction 1, facing each other within the OHT rail 10, and may be disposed to extend for each straight section, branch section, or confluence section of the OHT rail 10.

The steering wheel 120 may be configured on the upper surface of the traveling machine 100. The steering wheel 120 may move while being in contact with a side surface of a branch guide of the OHT rail 10 disposed above the traveling machine 100. The steering wheel 120 may rotate so that the traveling machine 100 changes the traveling direction.

The steering wheel 120 may change a position thereof in the first direction 1 on the upper surface of the traveling machine 100. The position of the steering wheel 120 may be changed using a solenoid or LM guide method.

The guide wheels 130 may be configured as a pair spaced apart from each other on a lower surface of the traveling machine 100, facing each other in the first direction 1. The pair of guide wheels 130 may support the movement of the traveling machine 100. The pair of guide wheels 130 may each rotate in contact with the side surfaces of the pair of rails 11 and move together with the traveling machine 100.

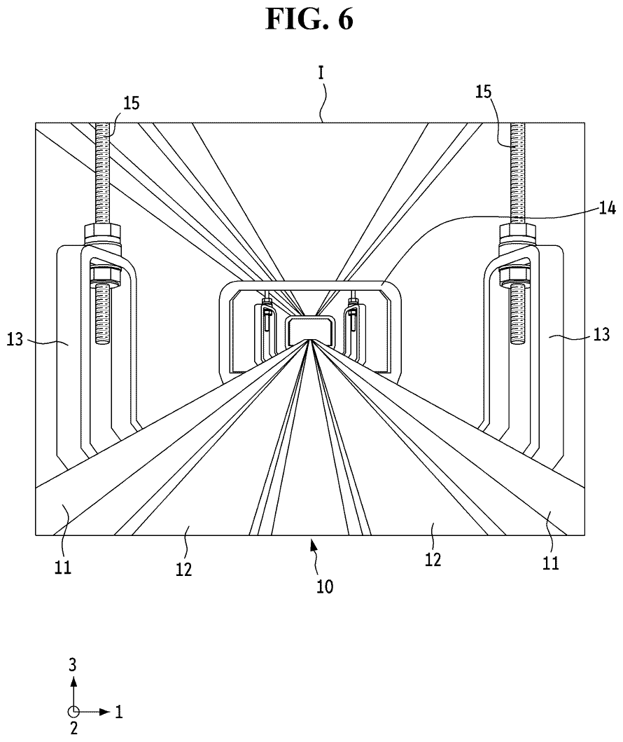

FIG. 6 is a diagram schematically illustrating a rail area image acquired by an optical system of the rail inspection device according to some exemplary embodiments of the present disclosure.

Referring to FIGS. 3 to 6, the optical system 140 may include a camera 141 and a plurality of lights 142. However, the technical spirit of the present disclosure is not limited thereto. For example, the optical system 140 may include a 3D scanner.

The optical system 140 may acquire an image I of an OHT rail area where the traveling machine 100 is traveling. The optical system 140 may provide a picture within the OHT rail 10 to an image analyzer 210 as the rail area image I. The optical system 140 may provide a real-time image within the OHT rail 10 to the image analyzer 210 as the rail area image I. The optical system 140 may provide a recorded image within the OHT rail 10 to the image analyzer 210 as the rail area image I.

The camera 141 may be disposed on the front of the traveling machine 100 along the second direction 2. The camera 141 may be disposed at the center of the front of the traveling machine 100 along the first direction 1. The camera 141 may be disposed at the upper center of the front of the traveling machine 100 along the third direction 3. The camera 141 may be configured to protrude from the front of the traveling machine 100 in the second direction 2. The camera 141 may be connected to the image analyzer 210.

The camera 141 captures a front view of the rail inspection device D traveling in the second direction 2 within the OHT rail 10 and transmits the captured image to the image analyzer 210. The image captured by the camera 141 transmitted to the image analyzer 210 may be checked by an operator through a monitor 310 configured in a remote control 300 connected to the image analyzer 210.

When two or more traveling machines 100 are disposed in the rail inspection device D according to some exemplary embodiments of the present disclosure, the camera 141 may be configured on the traveling machine 100 disposed in front along the second direction 2, which is the traveling direction of the rail inspection device D.

The plurality of lights 142 may be disposed on the front of the traveling machine 100 along the second direction 2. The plurality of lights 142 may be disposed outside a perimeter of the camera 141 along the first direction 1 on the front of the traveling machine 100. The plurality of lights 142 may be disposed outside a perimeter of the camera 141 along the third direction 3 on the front of the traveling machine 100. The plurality of lights 142 may be configured to protrude from the front of the traveling machine 100 in the second direction 2. The plurality of lights 142 may be connected to the image analyzer 210 or the remote control 300.

The optical system 140 may acquire the rail area image I.

Referring to FIG. 6, the rail area image I may include a plurality of rails 11 that appear to have narrow intervals in the first direction 1 toward a vanishing point. The rail area image I may include a plurality of Litz wire supports 12 installed at intervals in the first direction 1 between the plurality of rails 11. The rail area image I may include a plurality of yokes 14 installed on the plurality of rails 11 at intervals in the second direction 2 toward the vanishing point.

The rail area image I may include a plurality of turn buckles 13 installed on the plurality of rails 11 at equal intervals along the second direction 2 with the yoke 14 interposed therebetween. In this case, the plurality of turn buckles 13 may appear to be disposed on both sides of the plurality of yokes 14 along the first direction 1.

The rail area image I may include ceiling supports 15 connected to upper portions of the plurality of turn buckles 13. In this case, the ceiling supports 15 may appear to be disposed in plural numbers in the rail area image I.

Referring again to FIGS. 1, 3, and 4, the main body 200 may include an image analyzer 210, a battery 220, and a door 230. The main body 200 may have a square box shape. However, the technical spirit of the present disclosure is not limited thereto. For example, the main body 200 may include a housing of various shapes.

The main body 200 may be disposed below the traveling machine 100. That is, the traveling machine 100 may be installed on an upper surface of the main body 200. The main body 200 may be connected to a lower surface of the traveling machine 100 along the third direction 3. The main body 200 may move according to the traveling the traveling machine 100.

The image analyzer 210 may be built into the main body 200. The image analyzer 210 may also be provided outside the main body 200. The image analyzer 210 may control the overall operation of the rail inspection device D. The image analyzer 210 may control an operation of the optical system 140. The image analyzer 210 may analyze an image acquired by the optical system 140. The image analyzer 210 may analyze the image acquired by the optical system 140 to determine whether the OHT rail 10 is properly installed and allow the operator to recognize the determination. The image analyzer 210 analyzes the image acquired by the optical system 140 to allow the operator to recognize a traveling environment (checking for substances that interfere with traveling) within the OHT rail 10 on which the rail inspection device D travels.

The image analyzer 210 may be a computing device, such as a workstation computer, a desktop computer, a laptop computer, or a tablet computer. The image analyzer 210 may also be a processor, a microprocessor, a central processing unit (CPU), or firmware. For example, the image analyzer 210 may be implemented by specific hardware, such as a general-purpose computer, a digital signal processor (DSP), a field programmable gate array (FPGA), or an application specific integrated circuit (ASIC).

Operations of the image analyzer 210 may be implemented as instructions stored on a machine-readable medium that may be read and executed by one or more processors. Here, the machine-readable media may include any mechanism for storing or transmitting information in a form readable by a machine (e.g., a computing device). For example, the machine-readable media may include a read only memory (ROM), a random access memory (RAM), a magnetic disk storage medium, an optical storage medium, or a flash memory device.

The image analyzer 210 may include a plurality of algorithms in which normal images of inspection target items (e.g., the rail 11, the Litz wire support 12, the turn buckle 13, the yoke 14, or the ceiling support 15) are trained in an area of the OHT rail where the traveling machine 100 is traveling along the second direction 2.

The battery 220 may be built into the main body 200. The battery 220 may be connected to the traveling machine 100, the optical system 140, and the image analyzer 210. The battery 220 may supply power to the traveling machine 100, the optical system 140, and the image analyzer 210. Through this, the rail inspection device D according to some exemplary embodiments of the present disclosure may be operated without the need for a separate power supply from the outside. However, the technical spirit of the present disclosure is not limited thereto. For example, the battery 220 may also be connected to the remote control 300. The battery 220 may also supply power to the remote control 300.

Referring again to FIG. 4, the door 230 may be configured on a side surface of the main body 200 along the first direction 1 or the second direction 2. The door 230 may open and close the inside of the main body 200. The image analyzer 210 or the battery 220 configured inside the main body 200 may be replaced through the door 230. The maintenance for the image analyzer 210 or the battery 220 configured inside the main body 200 may be performed through the door 230.

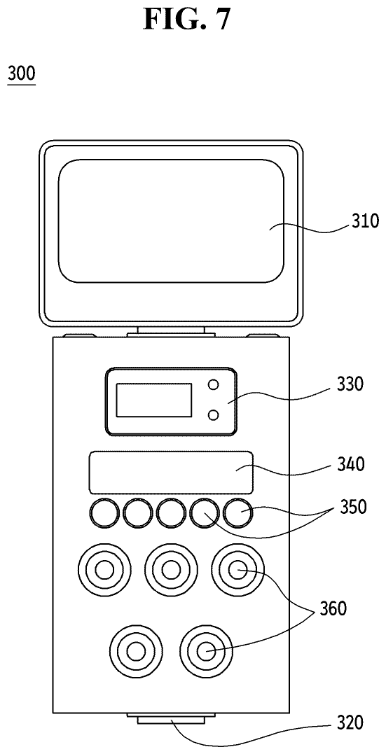

FIG. 7 is a cross-sectional view schematically illustrating a remote control of the rail inspection device according to some exemplary embodiments of the present disclosure.

Referring to FIGS. 1 and 7, the remote control 300 may be connected to the traveling machine 100. The remote control 300 may be connected to the main body 200. The remote control 300 may be connected to the image analyzer 210. The remote control 300 may be connected to the battery 220.

The remote control 300 may be connected to the traveling machine 100 by a traction means T in the form of a rod or wire. The remote control 300 may be connected to the main body 200 by a traction means T in the form of a rod or wire. The remote control 300 may be connected to the image analyzer 210 by a traction means T in the form of a rod or wire. The remote control 300 may be connected to the battery 220 by a traction means T in the form of a rod or wire.

The remote control 300 may be electrically connected to the image analyzer 210, which is electrically connected to the optical system 140, through a cable. The cable electrically connecting the remote control 300 and the image analyzer 210 may penetrate through the traction means T from the image analyzer 210 and be connected to the remote control 300. The cable electrically connecting the remote control 300 and the image analyzer 210 may be tied to the traction means T from the image analyzer 210 and connected to the remote control 300.

The remote control 300 may receive and display a signal regarding an installation status of the OHT rail 10 through the image analyzer 210.

The remote control 300 may manipulate the overall operation of the rail inspection device

D. The remote control 300 may manipulate the operations of the traveling machine 100, the optical system 140, and the image analyzer 210.

The remote control 300 allows an operator carrying the remote control 300 to directly drag the rail inspection device D through the traction means T and inspect the installation status of the desired section of the OHT rail 10.

The remote control 300 may include a cable expansion port 320. When a new optical system or separate sensor is additionally installed on the traveling machine 100 or the main body 200, the cable expansion port 320 may be configured in the remote control 300 so that the new optical system or the separate sensor and the image analyzer 210 may be connected, and then a connection cable C may be connected from the image analyzer 210.

That is, in order for the remote control 300 to receive an image or a signal extracted by the new optical system or the separate sensor, the connection cable C, which is a new cable, is connected to the cable expansion port 320 from the image analyzer 210.

The connection cable C may penetrate through the traction means T from the image analyzer 210 and be connected to the cable expansion port 320. The connection cable C may be tied to the traction means T from the image analyzer 210 and connected to the cable expansion port 320.

Here, the separate sensor that may be additionally installed may include one or more of a tilt sensor that measures a tilt of the traveling machine 100 or the main body 200, a displacement sensor that measures a rail width or rail height difference between the pair of rails 11, a cable protrusion detection sensor that senses protruding substances such as cables that may interfere with the traveling of the rail inspection device D within the OHT rail 10, or a barcode check sensor that checks a barcode attached to a lower surface of the pair of rails 11.

The remote control 300 may include a monitor 310, a battery confirmation window 330, an LCD notification window 340, an LED lamp 350, and a manipulation button 360. The remote control 300 may have a separate battery built in.

The monitor 310 may be connected to the image analyzer 210. An image I of the area of the OHT rail 10 may be displayed on the monitor 310. An image of a virtual area A set in the rail area image I may be displayed on the monitor 310. Images of the inspection target items within the OHT rail 10 may be displayed on the monitor 310. Normal Images of the inspection target items within the OHT rail 10 may be displayed on the monitor 310.

Through the monitor 310, the operator carrying the remote control 300 may directly check the rail area image I acquired by the optical system 140. Through the monitor 310, the operator carrying the remote control 300 may directly check the image of the inspection target item in the OHT rail 10 acquired by the optical system 140. Through the monitor 310, the operator carrying the remote control 300 may directly check the normal image of the inspection target item trained by the algorithm of the image analyzer 210. Through the monitor 310, the operator carrying the remote control 300 may directly check an inspection result of whether the OHT rail 10 is normally installed according to the algorithm of the image analyzer 210.

The battery confirmation window 330 allows the operator carrying the remote control 300 to directly check the remaining amount of the battery 220 built into the main body 200 or the remaining amount of the battery separately built into the remote control 300.

The LCD notification window 340 displays the inspection result of whether the OHT rail 10 is normally installed according to the algorithm of the image analyzer 210, which allows the operator carrying the remote control 300 to directly check the inspection result. The LCD notification window 340 may display, as “normal/abnormal”, the inspection result of whether the OHT rail 10 is normally installed according to the algorithm of the image analyzer 210.

One or more LED lamps 350 may be disposed on the remote control 300. A plurality of LED lamps 350 may be disposed on the remote control 300 to correspond to the inspection target items set on the OHT rail 10. The LED lamps 350 may be disposed to correspond to the plurality of rails 11. The LED lamps 350 may be disposed to correspond to the plurality of Litz wire supports 12. The LED lamps 350 may be disposed to correspond to the plurality of turn buckles 13. The LED lamps 350 may be disposed to correspond to the plurality of yokes 14. The LED lamps 350 may be disposed to correspond to the plurality of ceiling supports 15.

The LED lamp 350 may be turned on or off by receiving an inspection result signal of whether the OHT rail 10 is normally installed according to the algorithm of the image analyzer 210. The LED lamp 350 may be turned on or off when the inspection result of whether the OHT rail 10 is normally installed according to the algorithm of the image analyzer 210 is normal. The LED lamp 350 may be turned on or off when the inspection result of whether the OHT rail 10 is normally installed according to the algorithm of the image analyzer 210 is abnormal.

The LED lamp 350 may be turned on or off when an inspection result of an external state of the plurality of rails 11 according to the algorithm of the image analyzer 210 is normal. The LED lamp 350 may be turned on or off when the inspection result of the external state of the plurality of rails 11 according to the algorithm of the image analyzer 210 is abnormal.

The LED lamp 350 may be turned on or off when an inspection result of an external state of the plurality of Litz wire supports 12 according to the algorithm of the image analyzer 210 is normal. The LED lamp 350 may be turned on or off when the inspection result of the external state of the plurality of Litz wire supports 12 according to the algorithm of the image analyzer 210 is abnormal.

The LED lamp 350 may be turned on or off when an inspection result of an assembled state of the plurality of turn buckles 13 according to the algorithm of the image analyzer 210 is normal. The LED lamp 350 may be turned on or off when the inspection result of the assembled state of the plurality of turn buckles 13 according to the algorithm of the image analyzer 210 is abnormal.

The LED lamp 350 may be turned on or off when an inspection result of whether the tilt, twist, or state fastened to the rail 11, of the plurality of yokes 14 is normal according to the algorithm of the image analyzer 210 is normal. The LED lamp 350 may be turned on or off when the inspection result of whether the tilt, twist, or state fastened to the rail 11, of the plurality of yokes 14 is normal according to the algorithm of the image analyzer 210 is abnormal.

The LED lamp 350 may be turned on or off when an inspection result of an assembled state of the plurality of ceiling supports 15 according to the algorithm of the image analyzer 210 is normal. The LED lamp 350 may be turned on or off when the inspection result of the assembled state of the plurality of ceiling supports 15 according to the algorithm of the image analyzer 210 is abnormal.

Here, a normal installation status reference value of the rail 11, the Litz wire support 12, the turn buckle 13, the yoke 14, or the ceiling support 15, which is the inspection target item of the OHT rail 10 may be set in various ways depending on the design specifications of the OHT rail 10 and the rail inspection device D.

One or more manipulation buttons 360 may be disposed on the remote control 300. The manipulation button 360 may manipulate an application of power to the traveling machine 100, the image analyzer 210, or the remote control 300. The manipulation button 360 may manipulate the traveling execution or stopping control of the traveling machine 100. The manipulation button 360 may manipulate a steering of the traveling machine 100.

Meanwhile, the image analyzer 210 of the rail inspection device D according to some exemplary embodiments of the present disclosure may set at least one virtual area A in the image I of the area of the OHT rail 10. The virtual area A may be set to a size that may confirm and measure the inspection target item. The image analyzer 210 may extract an item image of the inspection target item (e.g., the rail 11, the Litz wire support 12, the turn buckle 13, the yoke 14, or the ceiling support 15) within the virtual area A. The image analyzer 210 may inspect the inspection target item by comparing the extracted item image with the normal image of the inspection target item. The image analyzer 210 may inspect whether the OHT rail 10 is normally installed by inspecting the inspection target item.

Here, the setting of at least one virtual area A in the rail area image I may mean dividing the rail area image I into the virtual area A and the remaining area. In addition, the setting of at least one virtual area A in the rail area image I may blur the remaining area. However, the technical spirit of the present disclosure is not limited thereto. For example, the setting of at least one virtual area A in the rail area image I may be to treat the remaining area as white or black so that the area other than the virtual area A is not visible.

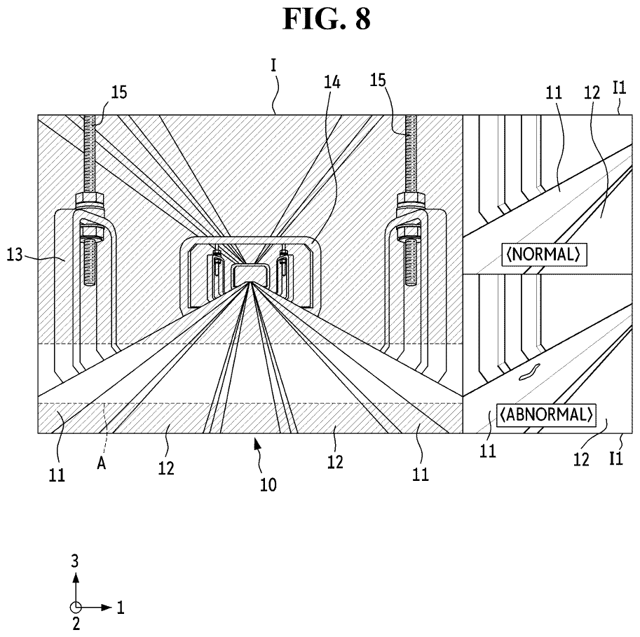

FIG. 8 is a schematic diagram for describing inspecting an external state of the rail by setting a virtual area in the rail area image acquired by the optical system of the rail inspection device according to some exemplary embodiments of the present disclosure, extracting an item image of the rail within the virtual area, and then comparing the item image of the rail with a normal image of the rail.

Referring to FIG. 8, the image analyzer 210 may inspect an external state of the inspection target item. The virtual area A may be set as a lower area along the third direction 3 perpendicular to the first direction 1 and the second direction 2 of the rail area image I. The virtual area A may include a rectangular box shape elongated in the first direction 1. Information on the plurality of rails 11 may be revealed in the virtual area A.

Here, the image analyzer 210 may include a plurality of algorithms in which the normal image of the inspection target item is trained. The inspection target item may include a plurality of rails 11. Item images I1 of the plurality of rails 11 may be acquired in real time through the optical system 140.

The image analyzer 210 may inspect whether an abnormal object including a scratch, damage, or particle exists on the plurality of rails 11 through the item images I1 of the plurality of rails 11.

The abnormal object may further include rail accessories or hand tools. Images of the rail accessories or the hand tools may be trained by at least one of the plurality of algorithms. The image analyzer 210 may inspect whether the abnormal object exists by checking whether the abnormal objects found on the plurality of rails 11 match.

When the abnormal object is not found on the plurality of rails 11 through the algorithm in which the normal image of the plurality of rails 11 is trained, the image analyzer 210 may determine the installation state of the OHT rail 10 as a normal state. When the abnormal object is found on the plurality of rails 11 through the algorithm in which the normal image of the plurality of rails 11 is trained, the image analyzer 210 may determine the installation state of the OHT rail 10 as an abnormal state.

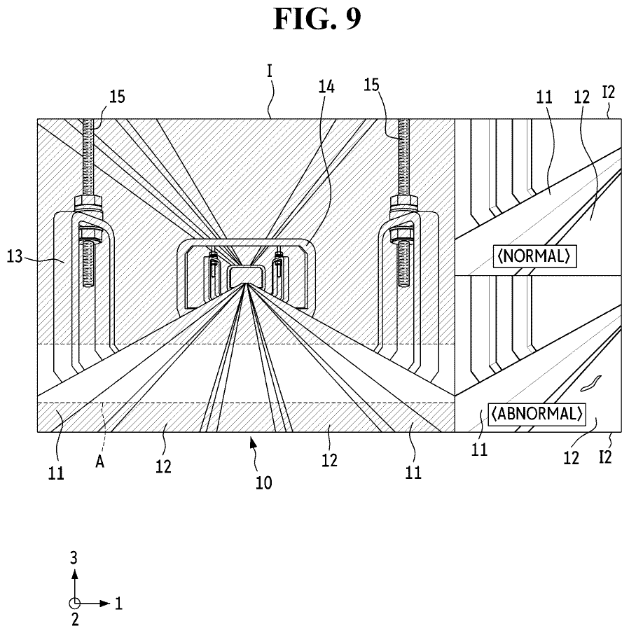

FIG. 9 is a schematic diagram for describing inspecting an external state of the Litz wire support by setting a virtual area in the rail area image acquired by the optical system of the rail inspection device according to some exemplary embodiments of the present disclosure, extracting an item image of the Litz wire support within the virtual area, and then comparing the item image of the Litz wire support with a normal image of the Litz wire support.

Referring to FIG. 9, the image analyzer 210 may inspect an external state of the inspection target item. The virtual area A may be set as a lower area along the third direction 3 perpendicular to the first direction 1 and the second direction 2 of the rail area image I. The virtual area A may include a rectangular box shape elongated in the first direction 1. Information on the plurality of Litz wire supports 12 may be revealed in the virtual area A.

Here, the image analyzer 210 may include a plurality of algorithms in which the normal image of the inspection target item is trained. The inspection target item may include a plurality of Litz wire supports 12. Item images 12 of the plurality of Litz wire supports 12 may be acquired in real time through the optical system 140.

The image analyzer 210 may inspect whether an abnormal object including a scratch, damage, or particle exists on the plurality of Litz wire supports 12 through the item images 12 of the plurality of Litz wire supports 12.

The abnormal object may further include rail accessories or hand tools. Images of the rail accessories or the hand tools may be trained by at least one of the plurality of algorithms. The image analyzer 210 may inspect whether the abnormal object exists by checking whether the abnormal objects found on the plurality of Litz wire supports 12 match.

When the abnormal object is not found on the plurality of Litz wire supports 12 through the algorithm in which the normal image of the plurality of rails 12 is trained, the image analyzer 210 may determine the installation state of the OHT rail 10 as a normal state. When the abnormal object is found on the plurality of Litz wire supports 12 through the algorithm in which the normal image of the plurality of Litz wire supports 12 is trained, the image analyzer 210 may determine the installation state of the OHT rail 10 as an abnormal state.

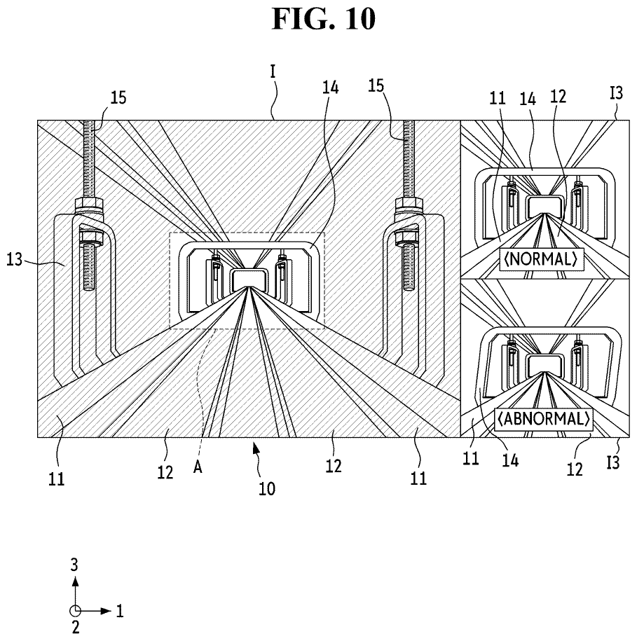

FIG. 10 is a schematic diagram for describing inspecting whether the yoke is normally installed by setting a virtual area in the rail area image acquired by the optical system of the rail inspection device according to some exemplary embodiments of the present disclosure, extracting an item image of the yoke within the virtual area, and then comparing the item image of the yoke with a normal image of the yoke.

Referring to FIG. 10, the image analyzer 210 may inspect an installation state of the inspection target item. The virtual area A may be set as a central area according to the first direction 1 of the rail area image I and the third direction 3 perpendicular to the first direction 1 and the second direction 2. The virtual area A may include a square box shape. Information on the yoke 14 may be revealed in the virtual area A.

Here, the image analyzer 210 may include a plurality of algorithms in which the normal image of the inspection target item is trained. The inspection target item may include the yoke 14. An item image 13 of the yoke 14 may be acquired in real time through the optical system 140. The item image 13 of the yoke 14 may be extracted only when the yoke 14 is captured in the virtual area A. The image analyzer 210 may inspect whether the yoke 14 is normally installed through the extracted item image 13 of the yoke 14.

The normal image of the yoke 14 may be trained by at least one of the plurality of algorithms. The image analyzer 210 may inspect whether the yoke 14 is tilted or twisted through the item image 13 of the yoke 14. The image analyzer 210 may inspect whether a state in which the yoke 14 is fastened to the rail 11 is normal through the item image 13 of the yoke 14. For example, when an angle of a corner of the yoke 14 deviates from a right angle, the tilt or twist of the yoke 14 may determine that the yoke 14 is in an abnormal installation state.

When the yoke 14 is not tilted or twisted through the algorithm in which the normal image of the yoke 14 is trained, the image analyzer 210 may determine the installation state of the OHT rail 10 as a normal state. When the yoke 14 is tilted or twisted through the algorithm in which the normal image of the yoke 14 is trained, the image analyzer 210 may determine the installation state of the OHT rail 10 as an abnormal state.

When the state in which the yoke 14 is fastened to the rail 11 is normal through the algorithm in which the normal image of the yoke 14 is trained, the image analyzer 210 may determine the installation state of the OHT rail 10 as a normal state. When the state in which the yoke 14 is fastened to the rail 11 is abnormal through the algorithm in which the normal image of the yoke 14 is trained, the image analyzer 210 may determine the installation state of the OHT rail 10 as an abnormal state. For example, the fact that the yoke 14 is abnormally fastened to the rail 11 may be determined by the presence/absence of fastening bolts, etc.

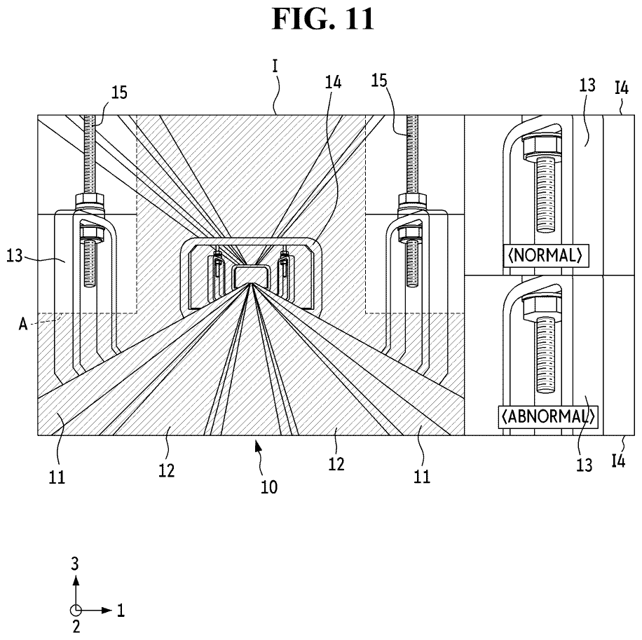

FIG. 11 is a schematic diagram for describing inspecting an assembled state of the turn buckles by setting a virtual area in the rail area image acquired by the optical system of the rail inspection device according to some exemplary embodiments of the present disclosure, extracting an item image of the turn buckle within the virtual area, and then comparing the item image of the turn buckle with a normal image of the turn buckle.

Referring to FIG. 11, the image analyzer 210 may inspect an assembled state of the inspection target item. The virtual area A may be formed along the third direction 3 perpendicular to the first direction 1 and the second direction 2 on both sides of the rail area image I along the first direction 1. The virtual area A may include a square box shape. Information on the plurality of turn buckles 13 may be revealed in the virtual area A.

Here, the image analyzer 210 may include a plurality of algorithms in which the normal image of the inspection target item is trained. The inspection target item may include a plurality of turn buckles 13. Item images 14 of the plurality of turn buckles 13 may be acquired in real time through the optical system 140. The item images 14 of the plurality of turn buckles 13 may be extracted only when the plurality of turn buckles 13 are captured in the virtual area A. The image analyzer 210 may inspect whether the plurality of turn buckles 13 are normally installed through the extracted item images 14 of the plurality of turn buckles 13.

The normal image of the plurality of turn buckles 13 may be trained by at least one of the plurality of algorithms. The image analyzer 210 may inspect an assembled state of the nuts, washers, or O-rings included in the plurality of turn buckles 13 through the item images 14 of the plurality of turn buckles 13. The image analyzer 210 may inspect an assembled state of the components of the plurality of turn buckles 13 through the item images 14 of the plurality of turn buckles 13. The image analyzer 210 may check the presence/absence of nuts, washers, or O-rings, which are the components of the plurality of turn buckles 13. The image analyzer 210 may check whether clearance has occurred between the nuts, washers, or O-rings, which are the components of the plurality of turn buckles 13.

When it is confirmed that all of the nuts, washers, and O-rings, which are the components of the plurality of turn buckles 13, exist at correct positions through the algorithm in which the normal image of the plurality of turn buckles 13 is trained, the image analyzer 210 may determine the installation state of the OHT rail 10 as a normal state. When it is confirmed that all of the nuts, washers, and O-rings, which are the components of the plurality of turn buckles 13, do not exist at the correct positions through the algorithm in which the normal image of the plurality of turn buckles 13 is trained, the image analyzer 210 may determine the installation state of the OHT rail 10 as an abnormal state. When it is confirmed that the nuts, washers, and O-rings, which are the components of the plurality of turn buckles 13, do not exist through the algorithm in which the normal image of the plurality of turn buckles 13 is trained, the image analyzer 210 may determine the installation state of the OHT rail 10 as an abnormal state. For example, as illustrated in the abnormal state of FIG. 11, it may be confirmed that the O-ring has fallen off and does not exist.

When it is confirmed that the clearance has not occurred between the nuts, washers, and O-rings, which are the components of the plurality of turn buckles 13, through the algorithm in which the normal image of the plurality of turn buckles 13 is trained, the image analyzer 210 may determine the installation state of the OHT rail 10 as a normal state. When it is confirmed that the clearance has occurred between the nuts, washers, and O-rings, which are the components of the plurality of turn buckles 13, through the algorithm in which the normal image of the plurality of turn buckles 13 is trained, the image analyzer 210 may determine the installation state of the OHT rail 10 as an abnormal state.

The inspection of the assembled state of the components of the plurality of turn buckles 13 may be converting a coincidence rate with an assembly reference value of the components set according to the normal image of the plurality of turn buckles 13 trained by the algorithm into a percentage.

Since it is confirmed that the plurality of turn buckles 13 are normally installed when the converted value is included in the range of a preset assembly reference value, the image analyzer 210 may determine the installation state of the OHT rail 10 as a normal state. Since it is confirmed that the plurality of turn buckles 13 are abnormally installed when the converted value deviates from the range of the preset assembly reference value, the image analyzer 210 may determine the installation state of the OHT rail 10 as an abnormal state.

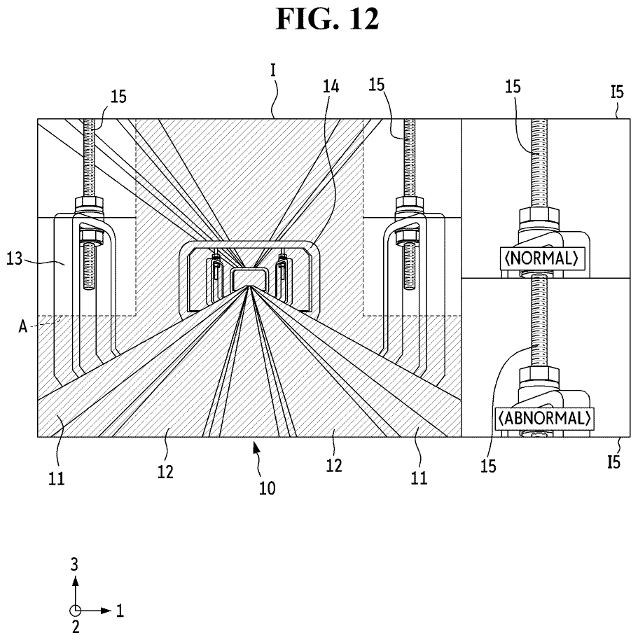

FIG. 12 is a schematic diagram for describing inspecting an assembled state of the ceiling supports by setting a virtual area in the rail area image acquired by the optical system of the rail inspection device according to some exemplary embodiments of the present disclosure, extracting an item image of the ceiling support within the virtual area, and then comparing the item image of the ceiling support with a normal image of the ceiling support.

Referring to FIG. 12, the image analyzer 210 may inspect an assembled state of the inspection target item. The virtual area A may be formed along the third direction 3 perpendicular to the first direction 1 and the second direction 2 on both sides of the rail area image I along the first direction 1. The virtual area A may include a square box shape. Information on the plurality of ceiling supports 15 may be revealed in the virtual area A.

Here, the image analyzer 210 may include a plurality of algorithms in which the normal image of the inspection target item is trained. The inspection target item may include a plurality of ceiling supports 15. Item images 15 of the plurality of ceiling supports 15 may be acquired in real time through the optical system 140. The item images 15 of the plurality of ceiling supports 15 may be extracted only when the plurality of ceiling supports 15 are captured in the virtual area A. The image analyzer 210 may inspect whether the plurality of ceiling supports 15 are normally installed through the extracted item images 15 of the plurality of ceiling supports 15.

The normal image of the plurality of ceiling supports 15 may be trained by at least one of the plurality of algorithms. The image analyzer 210 may inspect an assembled state of nuts, washers, or O-rings included in the plurality of ceiling supports 15 through the item images 15 of the plurality of ceiling supports 15. The image analyzer 210 may inspect an assembled state of the components of the plurality of ceiling supports 15 through the item images 15 of the plurality of ceiling supports 15. The image analyzer 210 may check the presence/absence of nuts, washers, or O-rings, which are the components of the plurality of ceiling supports 15. The image analyzer 210 may check whether clearance has occurred between the nuts, washers, or O-rings, which are the components of the plurality of ceiling supports 15.

When it is confirmed that all of the nuts, washers, and O-rings, which are the components

of the plurality of ceiling supports 15, exist at correct positions through the algorithm in which the normal image of the plurality of ceiling supports 15 is trained, the image analyzer 210 may determine the installation state of the OHT rail 10 as a normal state. When it is confirmed that all of the nuts, washers, and O-rings, which are the components of the plurality of ceiling supports 15, do not exist at the correct positions through the algorithm in which the normal image of the plurality of ceiling supports 15 is trained, the image analyzer 210 may determine the installation state of the OHT rail 10 as an abnormal state. When it is confirmed that the nuts, washers, and O-rings, which are the components of the plurality of ceiling supports 15, do not exist through the algorithm in which the normal image of the plurality of ceiling supports 15 is trained, the image analyzer 210 may determine the installation state of the OHT rail 10 as an abnormal state. For example, as illustrated in the abnormal state of FIG. 12, it may be confirmed that the washer has fallen off and does not exist.

When it is confirmed that the clearance does not occur between the nuts, washers, and O-rings, which are the components of the plurality of ceiling supports 15 through the algorithm in which the normal image of the plurality of ceiling supports 15 is trained, the image analyzer 210 may determine the installation state of the OHT rail 10 as a normal state. When it is confirmed that the clearance has occurred between the nuts, washers, and O-rings, which are the components of the plurality of ceiling supports 15 through the algorithm in which the normal image of the plurality of ceiling supports 15 is trained, the image analyzer 210 may determine the installation state of the OHT rail 10 as an abnormal state.

The inspection of the assembled state of the components of the plurality of ceiling supports 15 may be converting a coincidence rate with an assembly reference value of the components set according to the normal image of the plurality of ceiling supports 15 trained by the algorithm into a percentage.

Since it is confirmed that the plurality of ceiling supports 15 are normally installed when the converted value is included in the range of a preset assembly reference value, the image analyzer 210 may determine the installation state of the OHT rail 10 as a normal state. Since it is confirmed that the plurality of ceiling supports 15 are abnormally installed when the converted value deviates from the range of the preset assembly reference value, the image analyzer 210 may determine the installation state of the OHT rail 10 as an abnormal state.

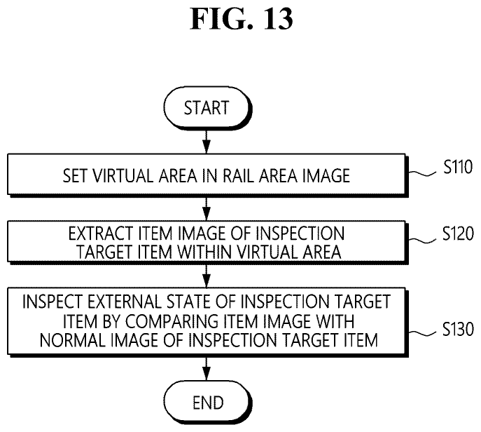

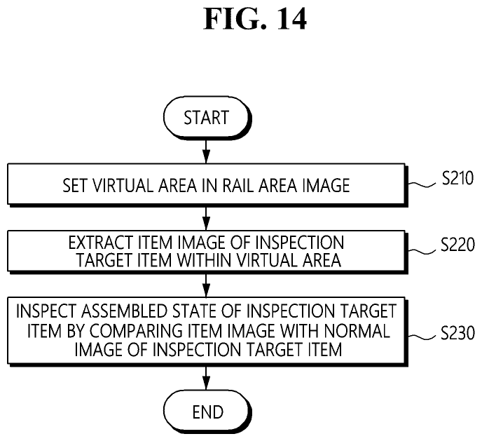

Hereinafter, a rail inspection method according to some exemplary embodiments of the present disclosure will be described with reference to FIGS. 13 and 14 while referring again to FIGS. 8 to 12.

FIGS. 13 and 14 are flowcharts schematically illustrating a rail inspection method using the rail inspection device according to some exemplary embodiments of the present disclosure.

Referring FIGS. 13 and 14 while referring again to FIGS. 8 to 12, in the rail inspection method according to some exemplary embodiments of the present disclosure, first, at least one virtual area A is set in the rail area image I through the image analyzer 210 (S110, S210).

Furthermore, a normal image of the inspection target item (the rail 11, the Litz wire support 12, the turn buckle 13, the yoke 14, or the ceiling support 15) is first trained for the algorithm of the image analyzer 210.

Next, within the virtual area A, item images Il to 15 of the inspection target items (the rail 11, the Litz wire support 12, the turn buckle 13, the yoke 14 or the ceiling support 15) are extracted (S120, S220).

Next, by inspecting the inspection target items (the rail 11, the Litz wire support 12, the turn buckle 13, the yoke 14 or the ceiling support 15) by comparing the extracted item images I1 to 15 with the normal image of the inspection target items (the rail 11, the Litz wire support 12, the turn buckle 13, the yoke 14 or the ceiling support 15), it may be confirmed whether the OHT rail 10 is normally installed (S130, S230).

Referring to FIGS. 8, 9, and 13, in order to inspect an external state of the inspection target item, the presence/absence of an abnormal object may be inspected. Inspecting the presence/absence of the abnormal object may mean checking the presence/absence of scratches, damage, particles, rail accessories, or hand tools on the plurality of rails 11 and the plurality of Litz wire supports 12 (S130).

Referring to FIGS. 11, 12, and 14, inspecting the assembled state of the inspection target item may mean converting a coincidence rate with an assembly reference value of the components set according to the normal image of the plurality of turn buckles 13 and the plurality of ceiling supports 15 into a percentage, and determining that the plurality of turn buckles 13 and the plurality of ceiling supports 15 are in an abnormal installation state when the converted value is less than or equal to the assembly reference value (S230).

Referring to FIG. 10, an installation state of the yoke 14 among the inspection target items may be inspected. Inspecting the installation state of the yoke 14 may mean inspecting whether a tilt, a twist, or a state fastened to the rail 11 of the yoke 14 is normal. In this case, when an angle of a corner of the yoke 14 deviates from a right angle, the tilt or twist of the yoke 14 may determine that the yoke 14 is in an abnormal installation state.

As described above, in the rail inspection device and method according to some exemplary embodiments of the present disclosure, as it is possible to check whether the OHT rail 10 is normally installed as a result of the analysis of the image analyzer 210, which analyzes the image acquired through the optical system 140, reliability of the inspection may be guaranteed regardless of the operator's competency or skill level, productivity may be improved by shortening the inspection time, and a safety of inspection work may also be ensured.

While embodiments in accordance with the disclosure have been described above with reference to the attached drawings, it will be understood that the present disclosure is not limited to the above embodiments and may be manufactured in various different forms, and those skilled in the art to which the present disclosure belongs, with ordinary knowledge in the field, may recognize that it may be implemented in other specific forms without changing the technical idea or essential features of the present disclosure. Therefore, it should be understood that the embodiments described above are examples in all respects and not limiting.

What is claimed is:

1. A rail inspection device comprising:
a traveling machine that travels along a rail and includes an optical system that acquires an image of an area of the rail being traveled; and
a main body having the traveling machine installed on an upper surface and including an image analyzer that analyzes the image acquired from the optical system,
wherein the image analyzer:
sets at least one virtual area in the rail area image,
extracts an item image of an inspection target item within the virtual area, and
inspects the inspection target item by comparing the extracted item image with a normal image of the inspection target item.

2. The rail inspection device of claim 1, wherein the rail area image includes:
a plurality of rails that appear to have narrow intervals in a first direction toward a vanishing point,
a plurality of Litz wire supports installed at intervals in the first direction between the plurality of rails,
a plurality of yokes installed on the plurality of rails at intervals in a second direction toward the vanishing point,
a plurality of turn buckles installed on the plurality of rails at equal intervals along the second direction with the yoke interposed therebetween and appearing to be disposed on both sides of the plurality of yokes in the first direction, and
a ceiling support connected to upper portions of the plurality of turn buckles.

3. The rail inspection device of claim 2, wherein the virtual area includes a rectangular box shape elongated in the first direction in a lower area along a third direction perpendicular to the first direction and the second direction of the rail area image, and reveals information on the plurality of rails and the plurality of Litz wire supports.

4. The rail inspection device of claim 3, wherein the image analyzer includes a plurality of algorithms through which the normal image of the inspection target item is trained,
the inspection target item includes the plurality of rails, and
the item image of the plurality of rails is acquired in real time through the optical system to inspect the presence/absence of abnormal objects including scratches, damage, or particles on the plurality of rails.

5. The rail inspection device of claim 4, wherein the abnormal object further includes a rail accessory or a hand tool, and
an image of the rail accessory or the hand tool is trained in at least one of the plurality of algorithms to inspect whether the image matches the abnormal object found on the plurality of rails.

6. The rail inspection device of claim 3, wherein the image analyzer includes a plurality of algorithms through which the normal image of the inspection target item is trained,
the inspection target item includes the plurality of Litz wire supports, and
the item image of the plurality of Litz wire supports is acquired in real time through the optical system to inspect the presence/absence of abnormal objects including scratches, damage, or particles on the plurality of Litz wire supports.

7. The rail inspection device of claim 6, wherein the abnormal object further includes a rail accessory or a hand tool, and
an image of the rail accessory or the hand tool is trained in at least one of the plurality of algorithms to inspect whether the image matches the abnormal object found on the plurality of rails.

8. The rail inspection device of claim 2, wherein the virtual area includes a rectangular box shape formed at a central area according to the first direction of the rail area image and a third direction perpendicular to the first direction and the second direction, and reveals information on the yoke.

9. The rail inspection device of claim 8, wherein the image analyzer includes a plurality of algorithms through which the normal image of the inspection target item is trained,
the inspection target item includes the yoke, and
the item image of the yoke is extracted only when the rail area image is acquired in real time through the optical system and the yoke is captured in the virtual area, and is used to inspect whether the yoke is normally installed.

10. The rail inspection device of claim 9, wherein a normal image of the yoke is trained in at least one of the plurality of algorithms to inspect whether a tilt, a twist, or a state fastened to the rail of the yoke is normal, and
the tilt or twist of the yoke determines that the yoke is in an abnormal installation state when an angle of a corner of the yoke deviates from a right angle.

11. The rail inspection device of claim 2, wherein the virtual area includes a square box shape formed along a third direction perpendicular to the first direction and the second direction on both sides of the rail area image along the first direction, and partitions and reveals information on the plurality of turn buckles and the plurality of ceiling supports.

12. The rail inspection device of claim 11, wherein the image analyzer includes a plurality of algorithms through which the normal image of the inspection target item is trained,
the inspection target item includes the plurality of turn buckles, and
the item image of the plurality of turn buckles is extracted only when the rail area image is acquired in real time through the optical system and the plurality of turn buckles are captured in the virtual area, and is used to inspect whether the plurality of turn buckles are normally installed.

13. The rail inspection device of claim 12, wherein a normal image of the plurality of turn buckles is trained in at least one of the plurality of algorithms to inspect an assembled state of a nut, a washer, or an O-ring included in the plurality of turn buckles,
the presence/absence of the nut, washer, or O-ring or whether clearance occurs between the nut, washer, or O-ring is measured, and the assembled state of components of the plurality of turn buckles is inspected, and
the inspection of the assembled state of the components of the plurality of turn buckles converts a coincidence rate with an assembly reference value of the components set according to the normal image of the plurality of turn buckles trained by the algorithm into a percentage, and determines that the plurality of turn buckles are in an abnormal installation state when the converted value is less than or equal to the assembly reference value.

14. The rail inspection device of claim 11, wherein the image analyzer includes a plurality of algorithms through which the normal image of the inspection target item is trained,
the inspection target item includes the plurality of ceiling supports, and
the item image of the plurality of ceiling supports is extracted only when the rail area image is acquired in real time through the optical system and the plurality of ceiling supports are captured in the virtual area, and is used to inspect whether the plurality of ceiling supports are normally installed.

15. The rail inspection device of claim 14, wherein a normal image of the plurality of ceiling supports is trained in at least one of the plurality of algorithms to inspect an assembled state of a nut, a washer, or an O-ring included in the plurality of ceiling supports,
the presence/absence of the nut, washer, or O-ring or whether clearance occurs between the nut, washer, or O-ring is measured, and the assembled state of components of the plurality of ceiling supports is inspected, and
the inspection of the assembled state of the components of the plurality of ceiling supports converts a coincidence rate with an assembly reference value of the components set according to the normal image of the plurality of ceiling supports trained by the algorithm into a percentage, and determines that the plurality of ceiling supports are in an abnormal installation state when the converted value is less than or equal to the assembly reference value.

16. The rail inspection device of claim 1, wherein the setting of the at least one virtual area in the rail area image divides the rail area image into the virtual area and the remaining area, and blurs the remaining area.

17. The rail inspection device of claim 1, wherein the main body has a built-in battery connected to the traveling machine, the optical system, and the image analyzer.

18. A rail inspection device comprising:
a traveling machine that travels along a rail and includes an optical system that acquires an image of an area of the rail being traveled; and
a main body having the traveling machine installed on an upper surface and including an image analyzer that analyzes the image acquired from the optical system,
wherein the image analyzer:
sets at least one virtual area in the rail area image,
extracts an item image of an inspection target item within the virtual area, and
inspects the inspection target item by comparing the extracted item image with a normal image of the inspection target item,
the rail area image includes a plurality of rails that appear to have narrow intervals in a first direction toward a vanishing point, a plurality of Litz wire supports installed at intervals in the first direction between the plurality of rails, a plurality of yokes installed on the plurality of rails at intervals in a second direction toward the vanishing point, a plurality of turn buckles installed on the plurality of rails at equal intervals along the second direction with the yoke interposed therebetween and appearing to be disposed on both sides of the plurality of yokes in the first direction, and a ceiling support connected to upper portions of the plurality of turn buckles,
the setting of the at least one virtual area in the rail area image divides the rail area image into the virtual area and the remaining area, and blurs the remaining area,
when the virtual area includes a rectangular box shape elongated in the first direction in a lower area along a third direction perpendicular to the first direction and the second direction of the rail area image, and reveals information on the plurality of rails and the plurality of Litz wire supports,
the image analyzer includes a plurality of algorithms through which the normal image of the inspection target item is trained,
the inspection target item includes the plurality of rails and the plurality of Litz wire supports, and
the item images of the plurality of rails and the plurality of Litz wire supports are acquired in real time through the optical system and used to inspect the presence/absence of abnormal objects including scratches, damage, particles, rail accessories, or hand tools on the plurality of rails and the plurality of Litz wire supports,
when the virtual area includes a rectangular box shape formed at a central area according to the first direction of the rail area image and a third direction perpendicular to the first direction and the second direction, and reveals information on the yoke,
the image analyzer includes a plurality of algorithms through which the normal image of the inspection target item is trained,
the inspection target item includes the yoke, and
the item image of the yoke is extracted only when the rail area image is acquired in real time through the optical system and the yoke is captured in the virtual area, and is used to inspect whether the yoke is normally installed, and
when the virtual area includes a square box shape formed along a third direction perpendicular to the first direction and the second direction on both sides of the rail area image along the first direction, and partitions and reveals information on the plurality of turn buckles and the plurality of ceiling supports,
the image analyzer includes a plurality of algorithms through which the normal image of the inspection target item is trained,
the inspection target item includes the plurality of turn buckles and the plurality of ceiling supports, and
the item images of the plurality of turn buckles and the plurality of ceiling supports are extracted only when the rail area image is acquired in real time through the optical system and the plurality of turn buckles and the plurality of ceiling supports are captured in the virtual area, and are used to inspect whether the plurality of turn buckles and the plurality of ceiling supports are normally installed.

19. A rail inspection method comprising:
providing a rail inspection device including: a traveling machine that travels along a rail and includes an optical system that acquires an image of an area of the rail being traveled; and a main body having the traveling machine installed on an upper surface and including an image analyzer that analyzes the image acquired from the optical system,
setting at least one virtual area in the rail area image,
extracting an item image of an inspection target item within the virtual area, and
inspecting the inspection target item by comparing the extracted item image with a normal image of the inspection target item,
wherein whether a rail is in a normal installation state is inspected by inspecting the presence/absence of an abnormal object to inspect an external state of the inspection target item or by inspecting an assembled state of the inspection target item.

20. The rail inspection method of claim 19, wherein the inspection target item includes a plurality of rails, a plurality of Litz wire supports, a plurality of turn buckles, and a plurality of ceiling supports,
the inspecting of the presence/absence of the abnormal object checks for the presence/absence of scratches, damages, particles, rail accessories or hand tools on the plurality of rails and the plurality of Litz wire supports,
the inspecting of the assembled state of the inspection target item converts a coincidence rate with an assembly reference value of the components set according to normal images of the plurality of turn buckles and the plurality of ceiling supports into a percentage, and determines that the plurality of turn buckles and the plurality of ceiling supports are in an abnormal installation state when the converted value is less than or equal to the assembly reference value,
the inspection target item further includes a yoke, and
whether a tilt, a twist, or a state fastened to the rail of the yoke is normal is inspected, and the tilt or twist of the yoke determines that the yoke is in an abnormal installation state when an angle of a corner of the yoke deviates from a right angle.
